(19) United States
(12) Patent Application Publication
(10) Pub. No.: US 2009/0072694 A1
(43) Pub. Date: Mar. 19, 2009

(54) Sparkplug having improved heat removal capabilities and method to recycle used sparkplugs

(76) Inventors: Robert Lee Steigleman, JR., Mira Loma, CA (US); Jimmy Robert Allen, II, Corona, CA (US)

Correspondence Address: ROBERT LEE STEIGLEMAN JR., 5800 HAMNER AVE, SPACE #631, MIRA LOMA, CA, 91752, US

(21) Appl. No.: 12/283,986

(22) Filed: Sep. 16, 2008

Related U.S. Application Data
(60) Provisional application No. 60/994,009, filed on Sep. 17, 2007.

(51) Int. Cl. H01T 13/00; H01T 21/02

(52) U.S. Cl. 313/118; 445/7

(57) ABSTRACT

Here in is disclosed a system of heat removal for the electrode part of a sparkplug that is used in the internal combustion engine. This is so as to use electrodes that have a very large mass as compared to the smaller, to very small electrodes, as in the case of using precious metals.

Here in is further disclosed a sparkplug that is made using recycled parts from old used sparkplugs.

### CROSS-REFERENCE TO RELATED APPLICATIONS

This application claims the benefits of provisional patent application, Ser. No. 60/994,009, Filed Sep. 17, 2007 by the present inventors, which is incorporated by reference here in.

### FEDERALLY SPONCERED RESEARCH

Not applicable

### SEQUENCE LISTING OR PROGRAMS

Not applicable

### BACKGROUND

1. Field

This application relates to the sparkplug of an internal combustion engine, and more particularly, to the efficiency of the heat removal process and core construction of that sparkplug.

2. Prior Art

In a 4 cycle internal combustion engine, the cycles are, starting at top dead center; this means that the piston is all the way at the top of the cylinder at the start of the cycle. The piston moves downward and the intake valve opens letting the air fuel mixture into the firing chamber, this is the intake cycle. When the piston reaches bottom dead center, the intake valve closes, and the piston moves up compressing the air fuel mixture, this is the compression cycle, and this creates a very fast moving wind storm type environment. When the piston reaches top dead center, the sparkplug will fire causing the compressed air fuel mixture to explode and force the piston downward, this is the power cycle. This is where the fuel is actually turned to kinetic energy that causes the internal combustion engine to operate. This is also where the heat is generated. When the piston reaches bottom dead center, the exhaust valve will open and the piston will move upward and force the burnt air fuel mixture out of the firing chamber, which is 1 revolution of the internal combustion engine. 1 revolution happens, from 800 to over 10,000 times a minute this is called revolutions per minute or RPM'S.

The internal combustion engine creates a lot of heat, some a little, some a lot. The present technology has been going towards smaller electrodes made of precious metals and the present technology, as far as the heat transfer is concerned, has been adequate. The technology of the larger more massive electrodes require a greater heat transfer than just the design of the insulator and its role in removing heat from the electrode. In recent years the demand of the sparkplug has been greatly diversified do to the fact that there is a tremendous diversity in the applications of the internal combustion engine. This diversity has created a demand for a more precise and wider range of heat transfer.

In the course of the operation of the internal combustion engine heat from the firing chamber will accumulate in the electrode and if this heat is not removed fast enough, that will cause the electrode to get red hot and the engine will pre-detonate, and eventually the electrode will be destroyed.

The standard sparkplugs generally have a relatively small positive electrode and very little ground area, the ground prong is generally welded to the shell and protrudes up and over the positive electrode.

### SUMMARY

With the preferred embodiments there is provided the removal of heat from the electrode of a sparkplug used in an internal combustion engine, so as to use larger more massive electrodes on that spark plug. This is done by adding a heat sink that the electrode can screw directly into. The heat sink adds surface area to the contacting surfaces of the electrode and insulator. The heat sink is located were the seal and resister are in conventional spark plugs. In the preferred embodiments a sealing ring is located between the electrode and the insulator at the end of the insulator that protrudes into the firing chamber, and the resistor is located just on the other side of the heat sink.

There is in addition provided the process of recycling used sparkplugs to restore them to a condition equal to or better than original, using the insulator and the shell of a previously used sparkplug.

There is in addition provided a complete core to replace the used cores of existing sparkplugs to be used in the process of recycling used sparkplugs.

### DRAWINGS—FIGURES

FIG. 1 is a front cut away view of the first embodiment 10.

FIG. 2 is a front cut away view of the electrode 20 showing its constituents.

FIG. 3 is a front cut away view of the seal ring 26 showing its constituents.

FIG. 4 is a front cut away view of the heat sink 24 showing its constituents.

FIG. 5 is an exploded perspective view of the first embodiment 10 showing the electrode 20 and the seal ring 26.

FIG. 6 is an exploded perspective view of standard spark plug.

FIG. 7 is a front cut away view of a standard spark plug after recycling preparation.

FIG. 8 is an exploded perspective view of the bolt core assembly.

FIG. 9 is a front cut away view of the bolt core terminal 22 showing its constituents.

FIG. 10 is a perspective view of the second embodiment.

DRAWINGS - Reference Numerals

| | | | |
|---|---|---|---|
| 10 | First Embodiment | 205 | External Threads |
| 12 | Second Embodiment | 207 | Electrode Seal Cup |
| 20 | Bolt Core Electrode | 22 | Bolt Core Terminal |
| 201 | Firing End | 221 | Terminal End |
| 225 | Internal Threads | 281 | Electrode Seal Surface |
| 227 | Terminal Seal Cup | 30 | Standard Insulator |
| 229 | Terminal Nut | 301 | Electrode End Seal Surface |
| 24 | Heat Sink | 303 | Terminal End Seal Surface |
| 241 | Cooling Fins | 32 | Shell |
| 243 | Heat Sink Internal Threads | 321 | Ground Prong |
| 26 | Seal Ring General | 323 | Replacement Ground Prong |
| 26E | Seal Ring used at Electrode | 34 | Standard Electrode |
| | End | | |
| 26T | Seal Ring used at Terminal | 36 | Standard Terminal |
| | End | | |
| 261 | Inside Surface | 38 | Resistor |
| 263 | Outside Surface | 40 | Cavity |
| 28 | Heat Sink Insulator | | |

### DETAILED DESCRIPTION

### First Embodiment

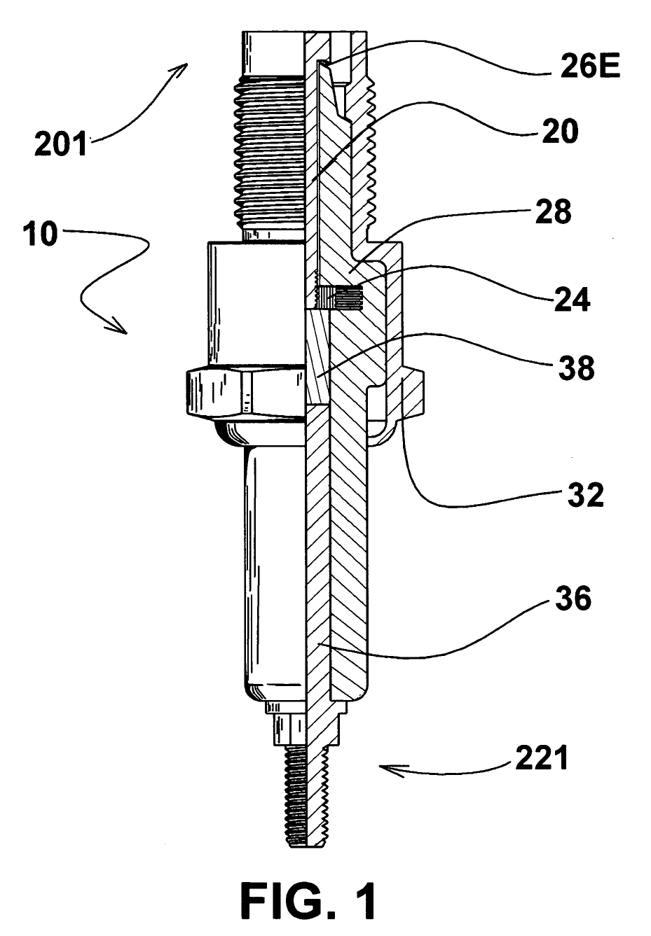

FIG. 1 shows a front cut away view of the first embodiment 10. A firing end 201 is used in reference to indicate the end that protrudes into the cylinder of the internal combustion engine. A terminal end 221 is used in reference to indicate the end that protrudes out of the head of the internal combustion engine where the high voltage from the distributor system is terminated. These terms will be used to reference the direction of parts and their constituents.

A heat sink 24 is located between a bolt core electrode 20 and a standard terminal 36. A resistor 38 is provided for the use in some applications but is not required. The heat sink 24, the bolt core electrode 20, the standard terminal 36 and the resistor 38, are lined contiguously from the terminal end 221 to the firing end 201 this is the core of the sparkplug. A heat sink insulator 28 is used for the electrical isolation of the core. The heat sink insulator 28 surrounds the core so that the firing end of the bolt core electrode 20 will protrude out of the firing end 201 of the sparkplug and the terminal end of the standard terminal 36 will protrude out of the firing end 221. A seal ring 26E is located at the firing end 201 sandwiched between the bolt core electrode 20 and the firing end of the heat sink insulator 28. A shell 32 surrounds the firing end portion of the heat sink insulator 28 and covers about half of the heat sink insulator 28.

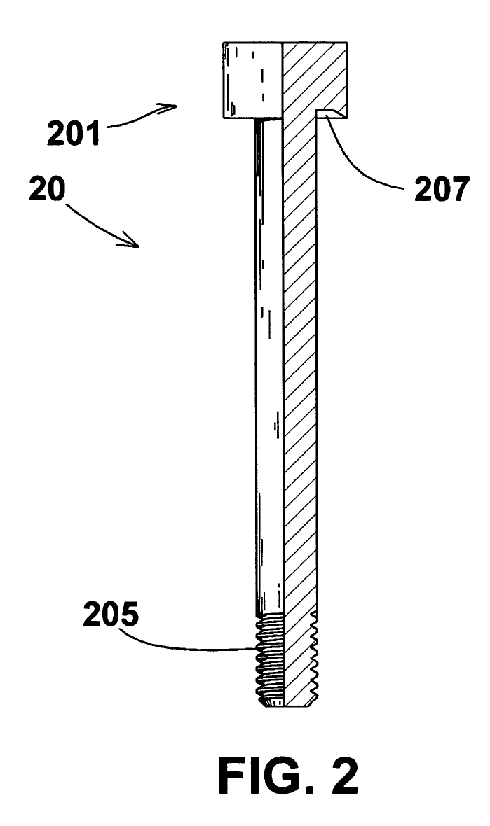

FIG. 2, shows the bolt core electrode 20 and its constituents.

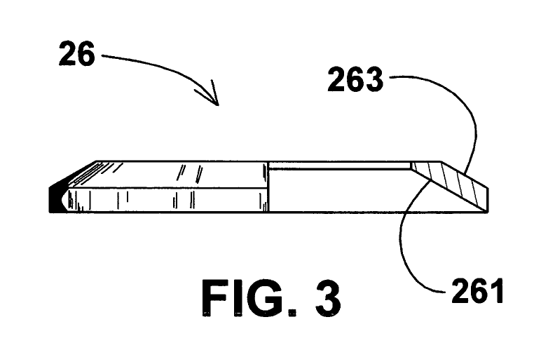

FIG. 3, shows the seal ring 26E and its constituents.

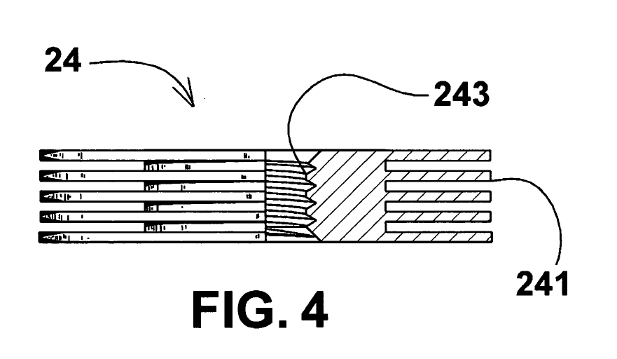

FIG. 4 shows the heat sink 24 and its constituents.

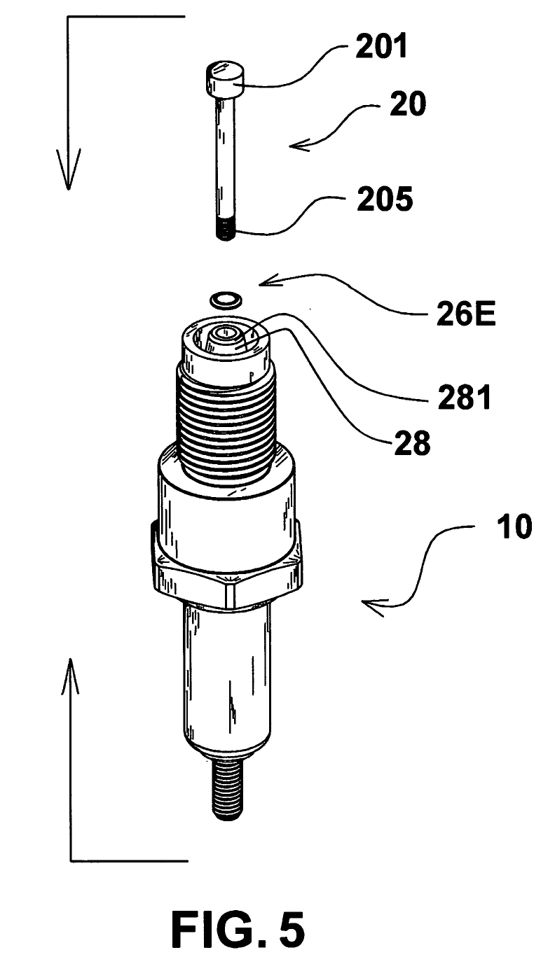

The parts and their constituents shown in FIGS. 2, 3 and 4 will be explained in the operations explanation of FIG. 5.

FIG. 5 shows the first embodiment 10, were the electrode 20 is inserted through the seal ring 26E and through the firing end of the heat sink insulator 28 and screws into the heat sink internal threads 243. The seal cup 207 of the bolt core electrode 20 is the same angle as surface area 241 with respect to the center line of the core. Surface area 263 of the sealing ring 26E is the same angle as sealing surface 281 of the heat sink insulator 28, also with respect to the center line of the core. Sealing ring 26E seals the high pressure of the air fuel mixture from leaking into the spark plug. The sealing ring 26E is made of a slightly softer material with respect to the bolt core electrode 20 so when it's sandwiched between the seal cup 207 of the bolt core electrode 20 and the electrode end seal surface 301 of the heat sink insulator 28, the screwing action of the bolt core electrode into the heat sink 24 will smash the seal ring 26E tight to seal off the core of the sparkplug from the firing chamber.

The external threads 205 of the bolt core electrode 20 screw tight into the internal threads 243 of the heat sink 24, this is a tight fit so as to create a direct path from the firing end of the bolt core electrode 20, through the electrode shaft 203 to the heat sink 24 were the heat will be removed from the core through the cooling fins 241 and through the heat sink insulator 28 and out through the shell 32 were it will dissipate into the cooling system of the engine. The heat sink 24 does this by greatly multiplying the surface area that comes in contact with the insulator 28 by use of cooling fins 241.

The heat sink 24 is made of a metallic material so as to be electro conductive to complete the distributor circuit between the terminal end 221, and the firing end 201 of the sparkplug. The heat sink 24 is disk shaped with the cooling fins 241 protruding out in a radial direction so as to surround the heat sink 24 and wrap around the core at a point in the middle where the heat sink insulator 28 and the shell 32 surround them.

The amount of heat that is removed can be precisely adjusted to fit the application by increasing the number of the cooling fins 241. By increasing the number of the cooling fins 241 we are again increasing the amount of surface area that comes in contact with the heat sink insulator 28. FIG. 4 shows the heat sink 24 with 5 cooling fins 241. This number of cooling fins 241 can be increased or decreased to precisely adjust the amount of heat that is removed. This is important because a sparkplug has to be set to operate at a certain temperature. If the electrode gets to hot it will cause the engine to pre-detonate resulting in damage to the engine. If it doesn't get hot enough it will not self clean and carbon will build up on the electrode and the shell portion that protrudes into the firing chamber and cause the sparkplug to foul out.

The firing end of the bolt core electrode 201 can be very large with respect to the standard sparkplug electrodes and basically any shape that is desired.

### Second Embodiment

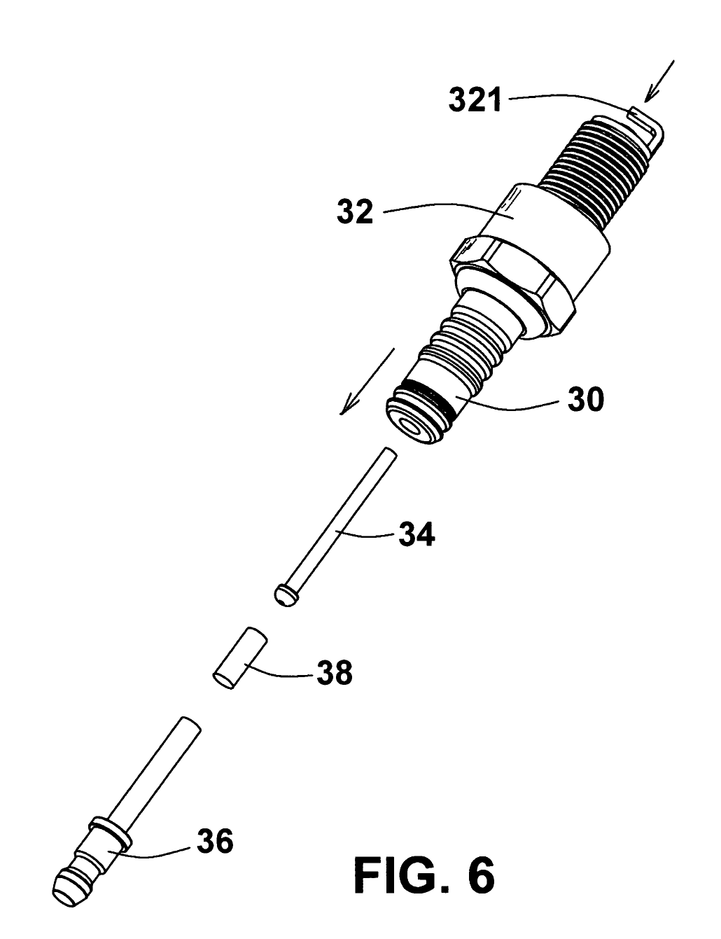

FIG. 6-FIG. 10 explain the recycling process and the parts needed to rebuild and reuse standard spark plugs that have been on the market for many years and are still on the market now. The recycling presses will restore a standard sparkplug to a condition as good as or better than original. The second embodiment reuses the standard insulator 30 and the shell 32.

FIG. 6 shows a standard sparkplug and how a standard electrode 34, a resistor 38 and a standard terminal 36 are arranged inside a standard insulator 30 and shell 32. A ground prong 321 is located at the firing end of the shell 32. The standard electrode 34 is placed in the standard insulator 30 so that the firing end protrudes out and comes in close proximity with the ground prong 321. The resistor 38 is placed in between the standard electrode 34 and the standard terminal 36. The function of the resistor 38 is to cancel out radio frequencies that are created by the high voltage of the spark. The radio frequencies may interfere with radios, stereos, citizen band radios and devices that use radio waves to operate, but the resistor is not required in many applications and can be added to the circuit at almost any point. The standard terminal 36 is placed in the standard insulator 30 so that the terminal end of the standard terminal 36 protrudes out. This for the connection of the high voltage from the distributor system that will pass though the core and discharge as the spark, between the firing end of the standard electrode 34 and the ground prong 321.

The first step is to remove the ground prong 321 by cutting it off and machining off the surface that it was welded to. This will precisely clean the surface in preparation for the attachment of the replacement prong 323.

The second step is to remove the used core. This can be done by pressing it out through the terminal end of the standard insulator 30, as shown by the arrows.

The third step is to remove the very outer layer of the shell 32 by using a corrosive material such as acid. The acid will dissolve the outer layer precisely even over the entire shell 32, down and into the raw metal completely removing everything on the surface. The acid will also remove 0.002″ to 0.005″ of the original material of shell 32. The acid will remove dirt and corrosion on the surface of the standard insulator 30, but will have no effect on the integrity of the material that the standard insulator 30 is made of.

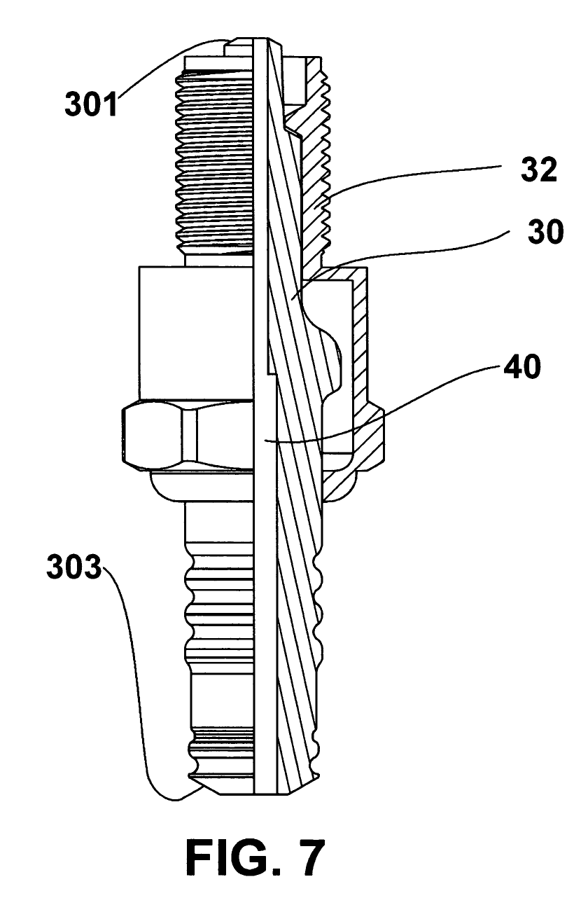

FIG. 7 shows the standard insulator 30 that is still assembled with the shell 32. There is a cavity 40 where the core was originally.

The fourth step is to machine chamfers on the standard insulator 30. An electrode seal surface 301 at the firing end and a terminal seal surface 303 at the terminal end. These will be at a predetermined angel, with respect to the center line. This angle will be the same as the angle of the inside surface 261 of the seal ring 26 shown in FIG. 3.

The fifth step is to assemble the bolt core electrode 20, the bolt core terminal 22, and the seal rings 26 inside the standard insulator 28.

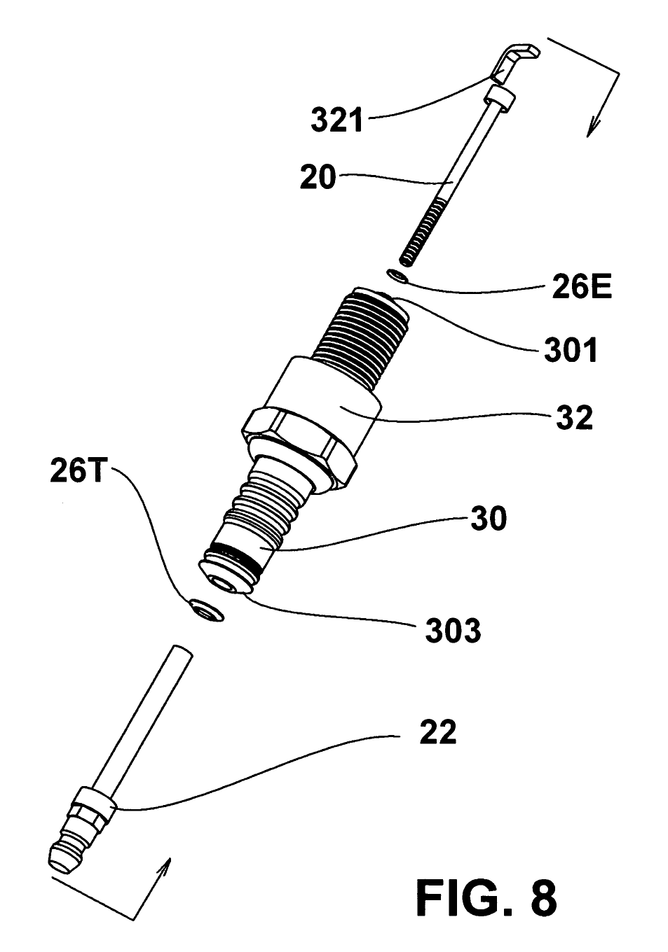

FIG. 8 shows how the bolt core electrode 20 passes through seal ring 26E and slides in through the firing end of the standard insulator 30. The bolt core terminal 22 passes through seal ring 26T and slides in through the terminal end of the standard insulator 30. At that point the bolt core electrode 20 and the bolt core terminal 22 will be screwed tight causing the seal ring 26E to be sandwiched contiguously between the electrode end seal surface 301 and the inside surface 261 of the seal ring 26E. This will also cause the seal ring 26T to be sandwiched contiguously between the terminal end seal surface 303 of the and the inside surface 261 of the seal ring 26T.

The sixth step is to permanently attach the replacement ground prong 323 to the firing end of the shell 32. This is usually done by welding, but can use any form of permanent attachment.

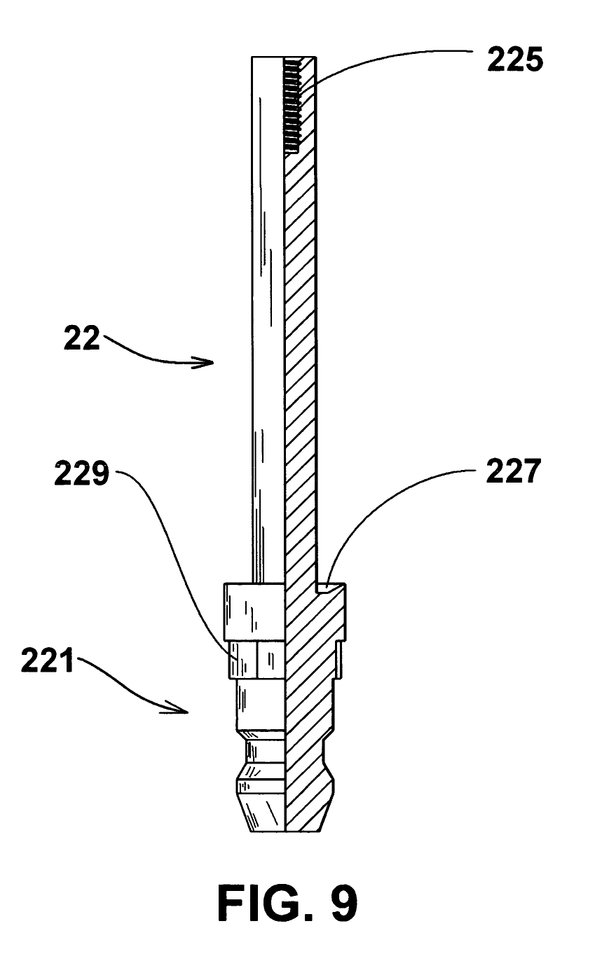

FIG. 9 further shows detail about the bolt core terminal 22. The terminal end 221 is where the high voltage is connected. The terminal nut 221 is used in step five to tighten the bolt core electrode 20 to the bolt core terminal 22. The internal threads 225 is where the external threads 205 of the bolt core electrode 20 screw into, in step five. Seal cup 227 is where the seal ring 26T will be after assembly.

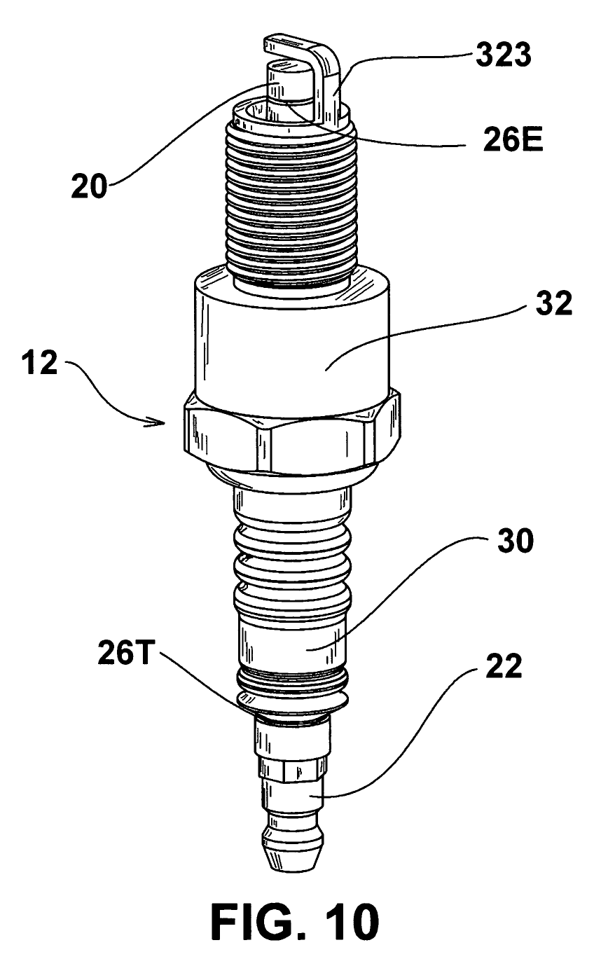

FIG. 10 shows the second embodiment 12 in its finished state. The standard insulator 30 and the shell 32 are parts that are recycled from used sparkplugs.

What is claimed is:

1. A sparkplug for the internal combustion engine comprising:
a. a terminal end and a firing end,
b. a core comprising an electrode, a heat sink, and a terminal,
c. an insulator that surrounds the said core,
d. and a shell that surrounds the insulator.

2. The sparkplug of claim 1, wherein said heat sink further comprises cooling fins.

3. The sparkplug of claim 2, wherein said electrode further comprises;
a. external threads,
b. and a seal cup,

4. The sparkplug of claim 3, wherein said terminal further comprises:
a. internal threads,
b. a seal cup,
c. and a terminal nut.

5. A method to recycle used sparkplugs comprising the steps:
a. The first step is to remove the ground prong by cutting it off and machining off the surface that it was welded to. This will precisely clean the surface in preparation for the attachment of the replacement prong,
b. the second step is to remove the used core. This can be done by pressing it out through the terminal end of the standard insulator,
c. the third step is to remove the very outer layer of the shell by using a corrosive material such as acid. The acid will dissolve the outer layer precisely even over the entire shell, down and into the raw metal completely removing everything on the surface. The acid will also remove 0.002″ to 0.005″ of the original material of shell. The acid will remove dirt and corrosion on the surface of the standard insulator, but will have no effect on the integrity of the material that the standard insulator is made of,
d. the fourth step is to machine chamfers on the standard insulator. An electrode seal surface at the firing end and a terminal seal surface at the terminal end, these will be at a predetermined angel, with respect to the center line, this angle will be the same as the angle of the inside surface of the seal ring,
e. the fifth step is to assemble the electrode, the terminal, and the seal rings inside the standard insulator, the electrode passes through the seal ring and slides in through the firing end of the standard insulator, the terminal passes through another seal ring and slides in through the terminal end of the standard insulator, at that point the electrode and the terminal will be screwed tight causing the seal rings to be sandwiched contiguously to the insulator,
f. the sixth step is to permanently attach the replacement ground prong to the firing end of the shell.
